(19) United States
(12) Patent Application Publication
(10) Pub. No.: US 2011/0309317 A1
(43) Pub. Date: Dec. 22, 2011

(54) DECK RAILING WITH LOW-VOLTAGE WIRING CONCEALMENT

(76) Inventor: John Paulin, Statham, GA (US)

(21) Appl. No.: 12/854,596

(22) Filed: Aug. 11, 2010

Related U.S. Application Data
(60) Provisional application No. 61/357,125, filed on Jun. 22, 2010.

(51) Int. Cl. E04H 17/14; B23P 17/04

(52) U.S. Cl. 256/19; 256/59; 29/428

(57) ABSTRACT

Deck railing systems and components that include internal channels for concealing low-voltage wiring improve the appearance of an exterior deck, while protecting low-voltage cables. The railing system includes upright supports, which may be formed from two portions having the channel formed on interior faces that are adhered together to form an upright support with an interior low-voltage cable channel. The railing system also includes horizontal members, which may be formed from a lower portion having a channel on a top surface and an upper cover portion for covering the top and a portion of the sides of the lower portion, so that the channel is completely enclosed. Low-voltage cables may be routed around the deck railing in the channels, completely concealing the cables. The components may be milled from lumber, or molded/extruded from a plastic material.

The present U.S. Patent Application claims priority under 35 U.S.C. §119(e) to U.S. Provisional Patent Application 61/357,125 filed on Jun. 22, 2010.

### BACKGROUND OF THE INVENTION

1. Field of the Invention

The present invention relates generally to milled wooden or molded composite handrails for outdoor decking use, and more particularly to milled or molded handrail components and systems that have channels formed for concealing low-voltage wiring.

2. Description of the Related Art:

Low-voltage lighting is frequently used in outdoor locations such as around the exterior of houses and around patios and outside decks in residential or commercial locations. A transformer, which provides a low-voltage output, e.g., 12 V, feeds a cable that is routed to each of the lights in a circuit. Other low voltage wiring may also be present around exterior decks, such as video, audio and telephone wiring.

In a deck installation, the above-described low-voltage wiring cable is typically fastened to the underside of the deck or deck handrail and is visible, in particular when the cables sag over time. Having visible cables is generally undesirable as they detract from the appearance of the deck and handrails. Further, fastening cables under a deck may not be practical or easy, depending on clearance and may be subject to damage during gardening operations. Cables fastened under a handrail may also be damaged during gardening, or during cleaning/re-surfacing of the deck.

Therefore, it would be desirable to provide a system for concealing and protecting low-voltage cabling in an exterior decking system.

### SUMMARY OF THE INVENTION

The above objectives, among others, are achieved in a deck railing system and components, along with their methods of installation and manufacture.

The deck railing components may be milled from lumber or molded/extruded from a plastic material and include an internal channel in which a low-voltage cable can be routed. The components include upright supports and horizontal rail members, either or both of which can contain the low-voltage cable. The upright supports may be formed from two portions having all or a portion of the channel milled or molded on a first surface of the portions, with the first surfaces bonded together with adhesive to form the upright support. The horizontal rail members may be formed with a lower portion having all or a portion of the channel formed on a top surface and a cover portion that fits over the top and sides of the lower portion to provide a handrail in which the channel is internal, completely concealing the cable.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1A is a cross-section view and FIG. 1B is a side view of a lower portion 10 of a horizontal deck railing member in accordance with an embodiment of the invention.

FIG. 1C is an isometric end view of a horizontal deck railing member in accordance with an alternative embodiment of the invention.

FIG. 2A is a cross-section view and FIG. 2B is a side view of an upper portion 12 of a horizontal deck railing member in accordance with an embodiment of the invention.

FIG. 3A is a cross-section view of a portion 15 of an upright support 17, shown in cross-section in FIG. 3B, a side view of which is shown in FIG. 3C.

FIG. 4 is a pictorial diagram illustrating a deck railing system in accordance with an embodiment of the invention.

FIG. 5 is a pictorial diagram illustrating a deck railing system in accordance with another embodiment of the invention.

### DESCRIPTION OF ILLUSTRATIVE EMBODIMENT

The present invention encompasses various components and a system for constructing decks and deck railings that include low-voltage wiring for supplying power to lighting and for interconnecting and powering other electrical/electronic devices. The railing components provide channels through which low-voltage cable is routed, completely concealing the cable where it is routed around a deck railing. The decking system of the present invention can also be used in fencing systems, where the fences are constructed from components that are similar to or identical to the decking system components described herein.

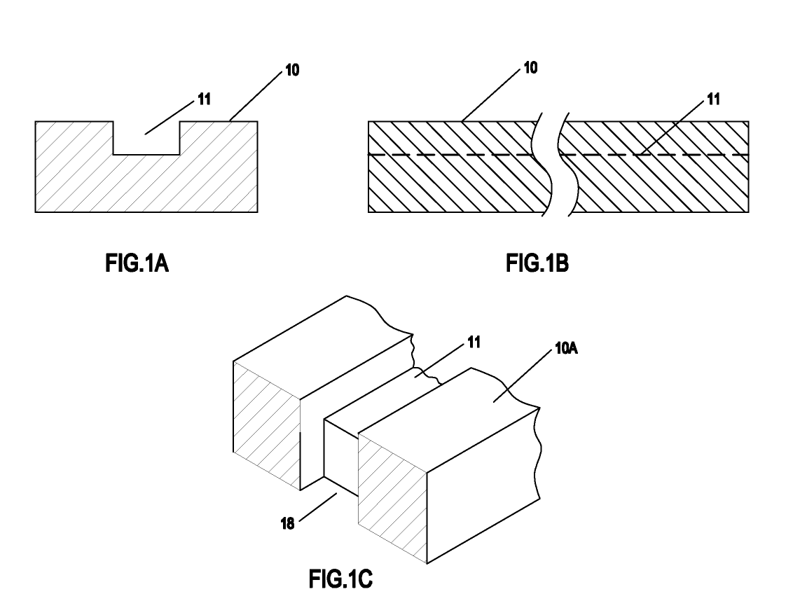

Referring to FIG. 1A and FIG. 1B, a cross-section view and a side view, respectively, of a lower portion 10 of a deck rail horizontal member is shown. A channel 11, for receiving one or more electrical cables, such as a 12V lighting wire for powering landscape lights that are attached to or disposed around/under a deck, is milled or otherwise formed in the top surface of lower portion 10. In the exemplary embodiment, channel 11 is 0.5 inches deep. The height of lower portion is approximately 1.5 inches and the width is approximately 3.5 inches in the exemplary embodiment, providing that a standard “2×4” lumber can be used for fabrication of lower portion 10. The length of a fabricated deck rail will generally be 8 feet or more, in two-foot increments as in standard lumber, and the depicted deck rail can be manufactured therefrom by a milling process or other suitable technique, such as extruding a composite thermoplastic material to form lower portion 10. As will be noted below, upper portions of the horizontal members will be longer than lower portions 10 in order to cover upright railing supports, so lower portions 10 may be shortened from the standard two-foot increments by an amount to compensate for the width of one or more upright supports.

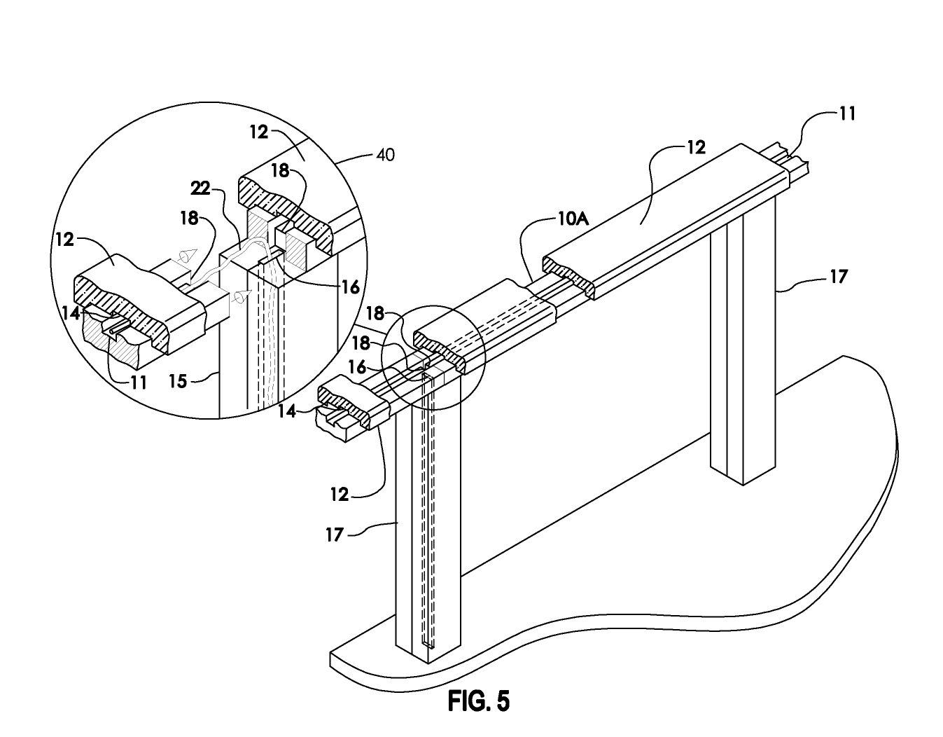

Referring to FIG. 1C, an isometric end view of a lower portion 10A in accordance with another embodiment of the present invention is shown. Lower portion 10A is identical to lower portion 10 as described above, except for additional features as described below. As will be illustrated below with reference to FIG. 5, the horizontal components of the deck rail system can be installed above the tops of vertical upright supports, as an alternative to installing them between the sides of the upright supports. When installed above the tops of the upright supports, a notch 18 can be provided at one or both ends of lower portion 10A, in order to provide a channel through lower portion 10A for a wire to be fed to channel 11 from a channel in one of the upright supports.

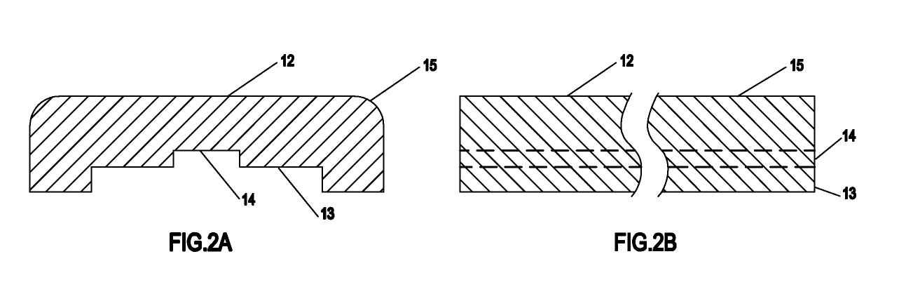

Referring to FIG. 2A and FIG. 2B, a cross-section view and a side view, respectively, of an upper portion 12 of a deck rail horizontal member is shown. A first channel 13, is formed on the underside of upper portion 12 and has a width slightly greater than a width of lower portion 10, so that upper portion 12 can be fitted over lower portion 10, enclosing channel 11. A second channel 14 is formed within first channel 13 to provide additional volume in conjunction with channel 11 for including connectors such as twist-on wire splices. However, channel 14 may be omitted if the additional volume is not required, and alternatively, channel 14 may be included and used with another lower portion that does not include a channel, so that channel 14 provides the entire routing volume for the low-voltage cable in the horizontal members when assembled. Sides of upper portion 12 are provide with smooth radius 15, to provide a suitable handrail feel and to protect against damage of the top corners of the deck handrail.

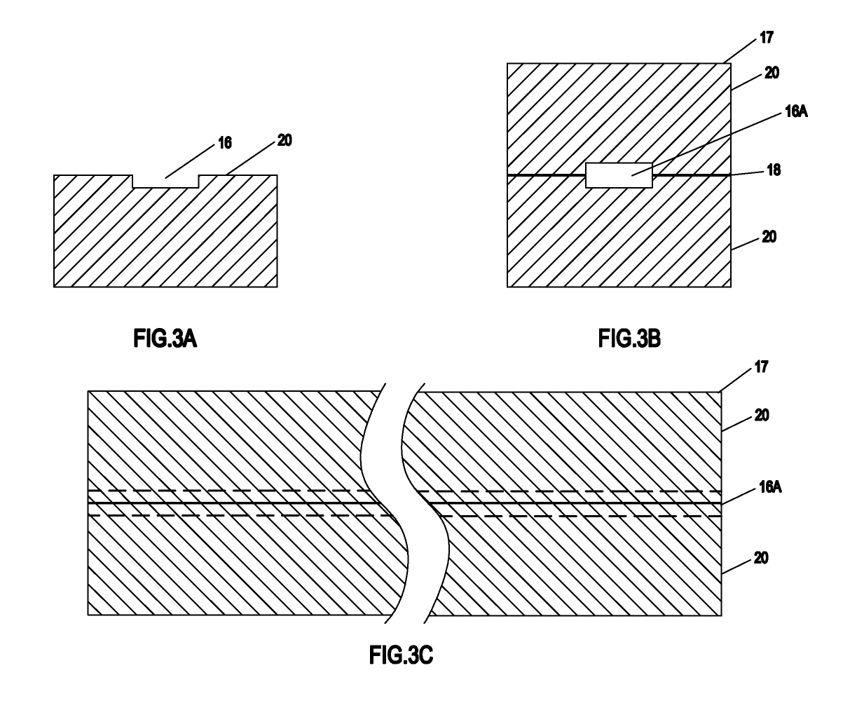

Referring to FIG. 3A, a cross-section view of a portion 20 of a deck railing upright support is shown. A channel 16 is formed in upright support portion 20, and in the exemplary embodiment has a depth of 0.188 inches. The width and height of upright support portion 20 in the exemplary embodiment are 3.5 inches and 1.75 inches, respectively, providing that the finished upright support will have the dimensions of a standard “4×4” when assembled as shown in FIG. 3B.

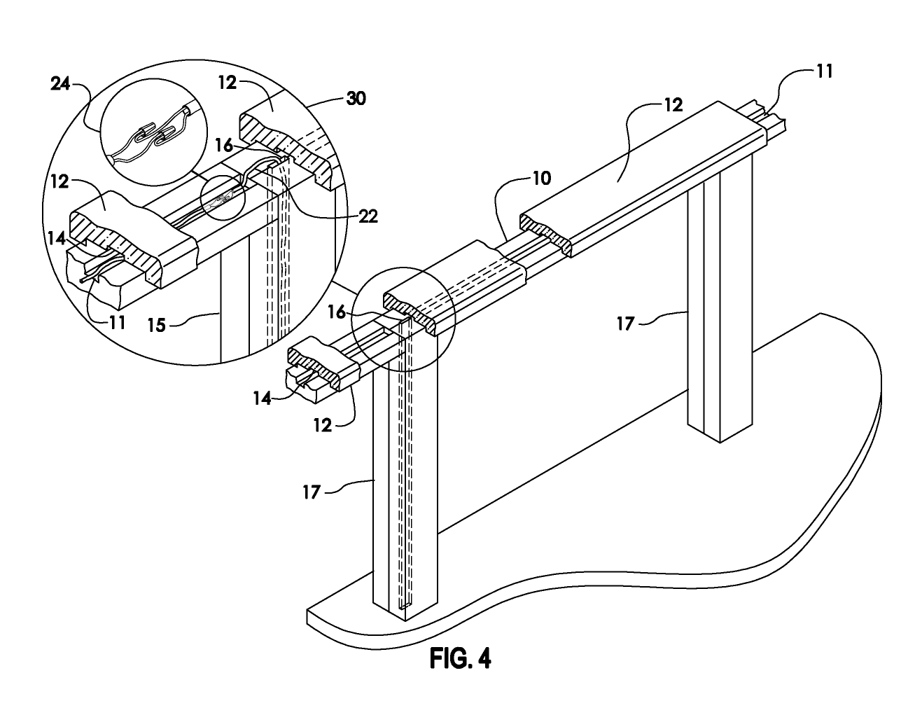

Referring now to FIG. 3B and FIG. 3C, a cross-section view and a side view, respectively, of a deck railing upright support 17 is shown. Two upright support portions 20 are adhered together by an adhesive 18 forming a channel 16A with a combined height of approximately 0.375, through which a low-voltage cable can be run and completely concealed/protected. The length of upright supports 17 are such that proper handrail height above the deck is provided at the top surface of the horizontal member upper portions 12, in the complete system as illustrated in FIG. 4 below.

Referring now to FIG. 4, a deck railing system in accordance with an embodiment of the invention is shown. In order to make a completely concealed and protected low-voltage wiring path, horizontal member lower portions 10 are butted and fastened between upright supports 17. Then horizontal member upper portions 12 are secured over lower portions 10 after low voltage cable 22 has been routed and any required splices 24 have been made. Channel 14 provides clearance for cable 22 to transition from the tops of upright supports 17 to channel 11 in horizontal member lower portions 10, as shown in detail in balloon 30. However, in an alternative embodiment, a horizontal channel can be milled/molded across the top end of upright supports 17 to effectively extend channel 11 across upright supports 17, in which case channel 14 may be optionally omitted from upper portions 12.

Transitions into and out of channels 11, 14 and 16A in the decking system can be made by holes drilled through to the channels, or for the bottom ends of upright supports 17 through the deck on which upright supports 17 rest, so that lighting fixtures, transformer connections and any other source or destination for low-voltage or signaling cabling can be connected. The above described deck railing system provides concealment and protection for cabling between such endpoints or mid-points. Further, while the above descriptions assume that the components are milled from wood, composite plastics or other plastic materials may be molded, extruded or otherwise shaped to provide alternative construction materials in the depicted forms, which are also contemplated to be within the scope of the invention.

Each of the above-described deck railing features can be included in a composite plastic component and appropriate manufacturing process in order to provide advantages such as those described above. While molds having the above-described cross sections are not explicitly shown, such molds are easily constructed for the cross sections illustrated and are well within the capabilities of a person of ordinary skill in the art to construct from the provided Figures.

Referring now to FIG. 5, a deck railing system in accordance with another embodiment of the invention is shown. The deck railing system of FIG. 5 is similar to the deck railing system of FIG. 4 as described above. Therefore, only differences between the two systems will be described in further detail below. In the deck railing system of FIG. 5, horizontal member lower portions 10A are butted and fastened above upright supports 17. Then horizontal member upper portions 12 are secured over lower portions 10A after low voltage cable 22 has been routed and any required splices 24 have been made. Channel 14 can be omitted from horizontal member upper portions 12 and notches 18 at the ends of lower portions 10A provides clearance for cable 22 to transition from channel 16A within upright supports 17 to channel 11 within horizontal member lower portions 10A. Details of which are shown in balloon 40. As an alternative to rectangular notches 18, a hole may be drilled through one or both horizontal member lower portions, such as horizontal member lower portion 10 as shown in FIGS. 1A-1B, to provide a channel through to channel 16A within upright supports 17.

Each of the above-described deck railing features can be included in a composite plastic component and appropriate manufacturing process in order to provide advantages such as those described above. While molds having the above-described cross sections are not explicitly shown, such molds are easily constructed for the cross sections illustrated and are well within the capabilities of a person of ordinary skill in the art to construct from the provided Figures.

While the invention has been particularly shown and described with reference to the preferred embodiment thereof, it will be understood by those skilled in the art that the foregoing and other changes in form, and details may be made therein without departing from the spirit and scope of the invention.

What is claimed is:

1. A deck railing system for exterior decking, comprising:
upright supports for supporting a horizontal rail above a decking surface; and
horizontal members forming the horizontal rail interconnecting the upright supports, wherein at least one of the upright supports or the horizontal members include at least one corresponding channel formed along a length thereof for containing a cable for electrical wiring.

2. The deck railing system of claim 1, wherein both the upright supports and the horizontal members include channels for containing the cable.

3. The deck railing system of claim 2, wherein the channels are arranged to completely enclose the cable when the railing system is assembled, whereby the cable is not visible from any angle along the at least one of the upright supports.

4. The deck railing system of claim 1, wherein the horizontal members comprise:
a lower portion having a first channel formed along a top surface thereof and extending the length of the lower portion; and
an upper portion having a second channel formed along a bottom surface thereof and extending the length of the upper portion, wherein the second channel has a width greater than a width of the lower portion, whereby the upper portion fits over the lower portion to cover the channel.

5. The deck railing system of claim 4, wherein the upper portion has a third channel formed along the bottom surface of the upper portion within the second channel and extending the length of the upper portion, wherein the third channel forms a single internal cavity with the first channel of the lower portion when the upper portion is assembled above the lower portion.

6. The deck railing system of claim 1, wherein both the upright supports and the horizontal members include channels for containing the cable, and wherein the horizontal members comprise:
a lower portion having a first channel formed along a top surface thereof and extending the length of the lower portion; and
an upper portion having a second channel formed along a bottom surface thereof and extending the length of the upper portion, wherein the second channel has a width greater than a width of the lower portion, whereby the upper portion fits over the lower portion to cover the channel.

7. The deck railing system of claim 1, wherein each of the upright supports comprise a pair of wooden support portions having the at least one corresponding channel formed in at least one of the pair of support portions on a first side of the at least one support portion, and wherein the first sides of the support portions are glued together to form the upright supports with the corresponding channel internal to the upright supports.

8. The deck railing system of claim 1, wherein the upright supports and the horizontal members are milled from lumber.

9. The deck railing system of claim 1, wherein the upright supports and the horizontal members are molded from a plastic material.

10. A method of making a deck railing, comprising
placing upright supports for supporting a horizontal rail above a decking surface; and
securing horizontal members forming the horizontal rail between or above the upright supports, wherein at least one of the upright supports or the horizontal members include at least one corresponding channel formed along a length thereof for containing a cable for electrical wiring; and
inserting the cable within the channel.

11. The method of claim 10, wherein both the upright supports and the horizontal members include channels for containing the cable.

12. The method of claim 11, wherein the channels are arranged to completely enclose the cable when the railing system is assembled, whereby the cable is not visible from any angle along the at least one of the upright supports.

13. The method of claim 10, further comprising forming the horizontal members by:
attaching a lower portion having a first channel formed along a top surface thereof and extending the length of the lower portion between the upright supports; and
covering the lower portion with an upper portion having a second channel formed along a bottom surface thereof and extending the length of the upper portion, wherein the second channel has a width greater than a width of the lower portion, whereby the upper portion fits over the lower portion to cover the channel.

14. The method of claim 13, wherein the upper portion has a third channel formed along the bottom surface of the upper portion within the second channel and extending the length of the upper portion, wherein the third channel forms a single internal cavity with the first channel of the lower portion when the upper portion is assembled above the lower portion.

15. The method of claim 1, further comprising forming the upright supports from a pair of wooden support portions having the at least one corresponding channel formed in at least one of the pair of support portions on a first side of the at least one support portion, by gluing the first sides of the support portions together to form the upright supports with the corresponding channel internal to the upright supports.

16. The method of claim 10, further comprising milling upright supports and the horizontal members from lumber.

17. The method of claim 10, further comprising molding the upright supports and the horizontal members from a plastic material.

18. A manufactured deck railing component, for forming one of an upright support or a horizontal rail member of an exterior deck, wherein the manufactured deck railing component includes an internal channel for containing a cable for electrical wiring.

19. The deck railing component of claim 18, wherein the deck railing component is an upright support comprising a pair of wooden support portions having all or a portion of the internal channel formed in at least one of the pair of support portions on a first side of the at least one support portion, and wherein the first sides of the support portions are glued together to form the upright support.

20. The deck railing component of claim 18, wherein the deck railing component is horizontal rail member comprising:
a lower portion having a first channel formed along a top surface thereof and extending the length of the lower portion; and
an upper portion having a second channel formed along a bottom surface thereof and extending the length of the upper portion, wherein the second channel has a width greater than a width of the lower portion, whereby the upper portion fits over the lower portion to cover the channel.
